(19) United States
(12) Patent Application Publication
(10) Pub. No.: US 2013/0034046 A1
(43) Pub. Date: Feb. 7, 2013

(54) ACCESS POINT DEVICE AND COMMUNICATION CONFIGURATION PROVIDING METHOD

(71) Applicants: Hideki ISHII, Nagoya-shi (JP); Goki Ichikawa, Nagoya-shi (JP); Yoshifumi Haba, Nagoya-shi (JP)

(72) Inventors: Hideki ISHII, Nagoya-shi (JP); Goki Ichikawa, Nagoya-shi (JP); Yoshifumi Haba, Nagoya-shi (JP)

(73) Assignee: Buffalo Inc., Nagoya-shi (JP)

(21) Appl. No.: 13/565,850

(22) Filed: Aug. 3, 2012

(30) Foreign Application Priority Data
Aug. 4, 2011 (JP) 2011-170975

(51) Int. Cl. H04W 88/00

(52) U.S. Cl. 370/315

(57) ABSTRACT

An access point enables wireless communication in a restricted state where a connection object is limited to less than full functionality. The access point change, in response to the specific instruction being received, changes the restricted state to a non-restricted state where the connection object is not limited, when receiving a specific instruction from a user. The access point sends configuration information for specified security communication between a wireless terminal and the access point or a setup program executed to cause the wireless terminal to obtain the configuration information, to the wireless terminal, when receiving an access from the wireless terminal establishing connection with the access point, in the non-restricted state. The access point returns from the non-restricted state to the restricted state on the occurrence of a specified event. This communication configuration technique is highly versatile and enables the configuration information to be readily set in the wireless terminal.

### CROSS-REFERENCE TO RELATED APPLICATIONS

This application claims the benefit of priority under 35 U.S.C. §119 to Japanese Patent Application No. 2011-170975 filed on Aug. 4, 2011, which is hereby incorporated by reference in its entirety and for all purposes.

### BACKGROUND OF THE INVENTION

1. Field of the Invention

The disclosure relates to communication configuration technique for wireless communication.

2. Description of the Related Art

In order to perform security communication ensuring security in a wireless LAN, it is required to set configuration information including encryption settings and authentication information in both an access point and a wireless terminal (station). The user's manual setup of such configuration information is rather troublesome, and the manual setup may be difficult for the user unfamiliar with the wireless LAN. The following technique (hereinafter referred to as “auto-configuration technique”) has accordingly been developed. This technique establishes mutual communication between the access point and the wireless terminal according to an asymmetric protocol and enables the access point to provide the wireless terminal with configuration information and automatically set the configuration information in the wireless terminal. Known examples of such auto-configuration technique include AOSS (AirStation One-Touch Secure System: registered trademark by BUFFALO INC.) and WPS (Wi-Fi Protected Setup).

In the auto-configuration technique, for example, the user presses a button provided on the access point and a button provided on the wireless terminal within a specified time to start specific communication between the access point and the wireless terminal and set the configuration information in the wireless terminal. This auto-configuration technique is enabled on the premise that a special program is installed in advance in the wireless terminal as well as in the access point. The auto-configuration technique is thus not able to set the configuration information in the wireless terminal without installation of the special program.

Consequently, by taking into account at least part of the above problem, there is a need to provide communication configuration technique that is highly versatile and enables configuration information to be readily set in a wireless terminal.

### SUMMARY

One aspect of the disclosure provides the configuration of an access point device. According to a first aspect, there is provided an access point device that relays wireless communication of a wireless terminal. In a non-restricted state where limitation of a connection object connectable with the access point device is cancelled, when receiving an access from a connected wireless terminal that is the wireless terminal establishing connection with the access point device, this access point device sends digital data, which is used to enable specified security communication between the connected wireless terminal and the access point device, to the wireless terminal. This enables the user to readily perform security communication between the wireless terminal and the access point device.

Another aspect of the disclosure provides the configuration of a communication configuration providing method. According to a second aspect, there is provided a communication configuration providing method that provides a wireless terminal with configuration information, which is used to enable specified security communication between an access point device and the wireless terminal. The communication configuration providing method changes a restricted state where a connection object connectable with the access point device is limited to a non-restricted state where the connection object is not limited, when receiving a specific instruction given by a user; sends digital data, which is used to cause a connected wireless terminal that has established connection with the access point device, to obtain the configuration information, to the connected wireless terminal, when receiving an access from the connected wireless terminal, in the non-restricted state; and returns from the non-restricted state to the restricted state on occurrence of a specified event after a restriction cancellation time when the restricted state is changed to the non-restricted state.

This method enables the configuration information to be readily set in the access point device.

The invention is not limited to the access point device or the communication configuration providing method described above but may also be implemented by various other applications, for example, a program for the access point device, a storage medium in which such a program is recorded and a communication configuration method.

### BRIEF DESCRIPTION OF THE DRAWINGS

FIG. 1 illustrates the general configuration of a network system 20 established by using an access point AP according to a first embodiment of the access point device of the disclosure;

FIG. 2 schematically illustrates the configuration of the access point AP;

FIG. 3 illustrates a specific example of virtual ports VAP0 to VAP3 implemented by the access point AP;

FIG. 4 schematically illustrates the configuration of a wireless terminal TE2;

FIG. 5 is a flowchart showing a procedure of connection setup process performed by the access point AP;

FIG. 6 is a flowchart showing a flow of first new setup process in the connection setup process;

FIG. 7 is a flowchart showing a flow of first configuration information transmission process in the first new setup process;

FIG. 8 is a flowchart showing a flow of second configuration information transmission process in the first new setup process;

FIG. 9 schematically illustrates the configuration of an access point AP2 according to a second embodiment;

FIG. 10 is a flowchart showing a flow of first new setup process performed by the access point AP2;

FIG. 11 is a flowchart showing a flow of first new setup process according to one modification of the second embodiment;

FIG. 12 schematically illustrates the configuration of an access point AP3 according to a third embodiment; and

FIG. 13 is a flowchart showing a flow of second configuration information transmission process performed by the access point AP3.

### DESCRIPTION OF THE PREFERRED EMBODIMENTS

### A. First Embodiment

The following describes embodiments of the disclosure with reference to the accompanying drawings.

### A-1. General Configuration of Network System 20

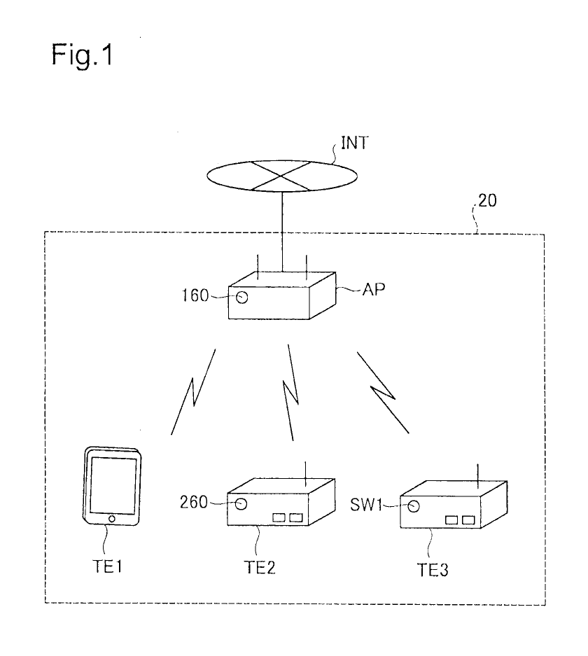

FIG. 1 illustrates the general configuration of a network system 20 established by using an access point AP as one embodiment of the access point device of the disclosure. According to this embodiment, the network system 20 is implemented as a wireless LAN in conformity with IEEE 802.11 standard. The network system 20 includes the access point AP and wireless terminals TE1 to TE3 as illustrated in FIG. 1.

The access point AP serves to relay wireless communication of the wireless terminals TE1 to TE3. This access point AP has the router function and is connected to the Internet INT by a network cable. According to this embodiment, the access point AP supports conventionally known AOSS and WPS processes as the auto-configuration to automatically provide the wireless terminal with configuration information for specified security communication, such as encryption settings and authentication information. The access point AP also supports a process of readily providing the wireless terminal with configuration information (hereinafter referred to as “new setup process”). The new setup process is the novel technique implemented according to this embodiment. The new setup process includes “first new setup process” to provide the wireless terminal with configuration information in the form of digital data in response to the simple user operation and “second new setup process” to automatically provide the wireless terminal with configuration information in the form of digital data. In the description below, the term “new setup process” is used as collective term including both the first new setup process and the second new setup process.

The access point AP has an easy setup button 160 operated by the user to give a specific instruction directly to the access point AP. The easy setup button 160 is operated to give an instruction to start AOSS process, WPS process or new setup process to the access point AP. According to this embodiment, the easy setup button 160 is used for all the AOSS process, the WPS process and the new setup process. According to another embodiment, separate buttons may be provided for the respective processes.

According to this embodiment, the wireless terminal TE1 is a general-purpose cell phone having a display and a wireless communication interface. This wireless terminal TE1 is a model that supports neither the auto-configuration, such as AOSS or WPS nor the second new setup process.

The wireless terminals TE2 and TE3 are Ethernet (registered trademark) converters. The Ethernet converter has a wireless communication interface and a wired LAN interface and performs format conversion based on these communication standards to relay communication packets. The wireless terminal TE2 supports the second new setup process and is provided with an easy setup button 260 to give a start command for the second new setup process. The wireless terminal TE2, however, does not support the auto-configuration, such as AOSS or WPS. The wireless terminal TE3, on the other hand, supports the auto-configuration, such as AOSS or WPS and is provided with an easy setup button SW1 to give a start command for the AOSS process or the WPS process. The device type of the wireless terminal is not limited to those described in this embodiment. The wireless terminal TE1 is any device having equipment serving as a user interface, for example, a display, and an interface for wireless communication and may be, for example, a personal computer, a PDA (personal digital assistant), a portable game machine or a home appliance. The wireless terminal TE2 may be, for example, a personal computer, a RDA, a printer, a stationary game machine or another electric appliance. The wireless terminal TE2 may not be provided with a display. The wireless terminal TE2 provided with a display may receive a start command for the second new setup process via GUI (Graphical User Interface) displayed by a program installed in the wireless terminal TE2.

The access point AP provides any of the wireless terminals TE1 to TE3 with configuration information, in response to the simple user operation. The following describes the configuration of the access point AP to provide the wireless terminals TE1 to TE3 with configuration information.

### A-2. General Configuration of Access Point AP

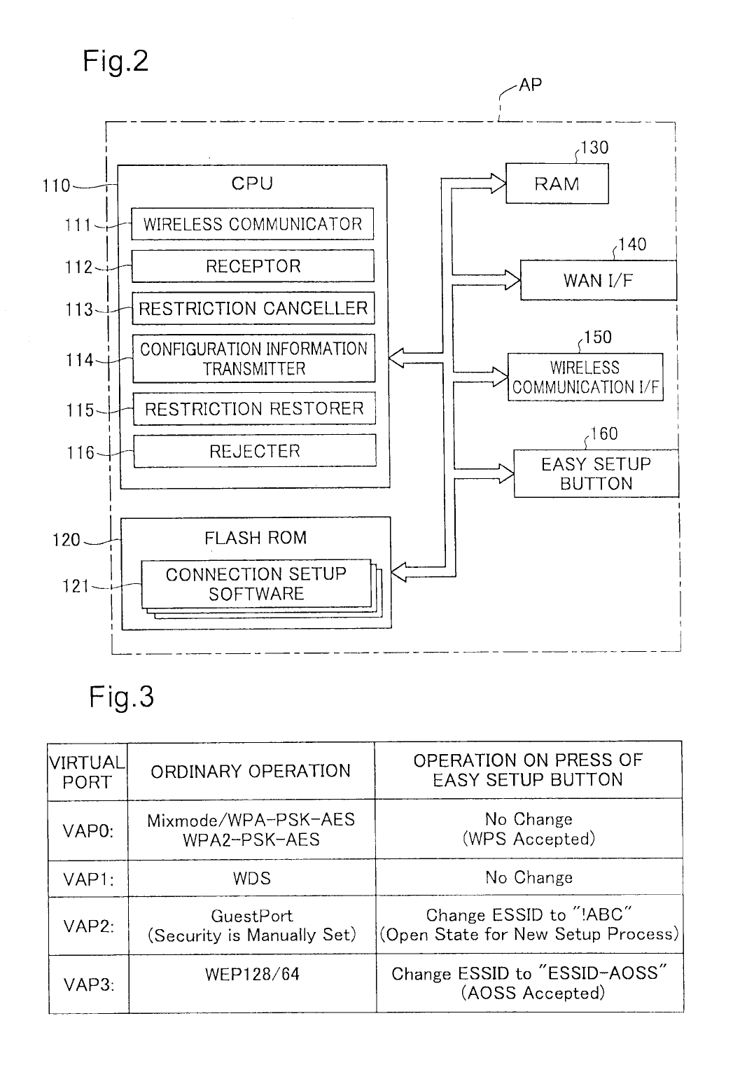

FIG. 2 schematically illustrates the configuration of the access point

AP. As illustrated, the access point AP has a CPU 110, a flash ROM 120, a RAM 130, a WAN interface (I/F) 140, a wireless communication interface 150 and the easy setup button 160. The CPU 110, the flash ROM 120, the RAM 130, the WAN interface WO 140, the wireless communication interface 150 and the easy setup button 160 are interconnected by a bus.

The CPU 110 loads and executes a program, such as firmware, stored in the flash ROM 120, on the RAM 130 to control the overall operations of the access point AP. The CPU 110 executes this program to serve as a wireless communicator 111, a receptor 112, a restriction canceller 113, a configuration information transmitter 114, a restriction restorer 115 and a rejecter 116. The details of these functional blocks will be described later.

Connection setup software 121 is recorded in the form of digital data in the flash ROM 120. The connection setup software 121 is a program executed to set the configuration information generated by the access point AP into the wireless terminal. This connection setup software 121 is sent in the form of digital data to the wireless terminal and is loaded and executed on a memory in the wireless terminal. Multiple pieces of the connection setup software 121 are provided corresponding to a plurality of different operating systems (OS) that may be installed in the wireless terminal. Examples of such OS include iOS, Android (registered trademark by Google Inc.), Windows (registered trademark by Microsoft Corporation). The “different operating systems” may include different versions of an identical. OS.

The WAN interface 140 is an interface for connecting with an external network by a fixed line. According to this embodiment, the WAN interface 140 is connected to the Internet INT as the external network. The wireless communication interface 150 is a control circuit for establishing wireless communication in conformity with a wireless LAN standard. The wireless communication interface 150 is provided with hardware, such as a modulator, an amplifier and an antenna. The wireless communication interface 150 is controlled by the CPU 110 or more specifically its wireless communicator 111 to implement the functions as the access point.

The easy setup button 160 is operated by the user to give a specific instruction, i.e., a start command for the AOSS process, the WPS process or the new setup process, to the access point AP as described above. The interface for receiving a start command is, however, not limited to the button. For example, in the access point AP provided with a display, the interface for receiving a start command may be GUI (Graphical User Interface). In another example, the interface for receiving a start command may be configured to use infrared communication or a contact or non-contact IC card. In general, the interface may be any input in the form of direct touch, i.e., directly operable by the user, or in the form of near field communication in the vicinity of the access point AP, to give a start command to the access point AP. This configuration advantageously prevents a start command from being given from a location distant from the access point AP to the access point AP without the user's acknowledgement or against the user's intention. From this point of view, the narrower coverage is preferable to give an instruction to the access point AP. For example, the coverage may be within a range of 10 meters from the access point AP, preferably within a range of 5 meters, or more preferably within a range of 1 meter. This coverage is most preferably within a range of 0 meter to allow the user to give a start command to the access point AP only by a direct touch on the access point AP.

The access point AP is configured to enable wireless communication in the restricted state. In the “restricted state”, the connection object connectable with the access point AP is limited. The connection object may be limited in any of various forms. Limiting the connection object in any form causes the access point AP to fall in the restricted state. According to this embodiment, the wireless communicator 111 of the CPU 110 has ANY connection refusal function and SSID (Service Set Identifier) concealing function as the functions to limit the connection object. The “ANY connection refusal function” refuses a connection request with the setting of an SSID to vacancy or ANY from the wireless terminal. The “SSID concealing function” excludes an SSID (more specifically ESSID (Extended Service Set Identifier) in this embodiment) from beacon sent by the access point AP at regular intervals. These functions limit the connection object connectable with the access point AP to the user's wireless terminal that is informed of the ESSID set in the access point AP, i.e., the wireless terminal with the setting of the same ESSID as the ESSID set in the access point AP.

In WPS-based or AOSS-based auto-configuration, even the user's wireless terminal that is not informed of the ESSID set in the access point AP is able to make a connection with the access point AP by detecting beacon from the access point AP and performing a connecting operation. In WPS-based or AOSS-based auto-configuration, however, the wireless terminal is required to support WPS or AOSS. Additionally, the user is required to give a start command for auto-configuration to both the access point AP and the wireless terminal within a specified period. This means that the access point AP is in the restricted state during the WPS-based or AOSS-based auto-configuration. The connection object may be limited, for example, by encrypting the ESSID included in beacon or by requiring the wireless terminal to provide authentication information before allowing connection with the access point AP.

The access point AP supports multi-SSID. More specifically, the access point AP is configured such that one physical access point AP is operable as a plurality of virtual access points that serve as logical access points. The access point AP is able to set an SSID for each virtual access point. This virtual access point is also called “virtual port” in the description hereof.

FIG. 3 illustrates a specific example of the virtual ports implemented by the access point AR In this illustrated example, the access point AP has four virtual ports VAP0 to VAP3. The virtual port VAP0 is used for encrypted communication in WPA (Wi-Fi Protected Access)—PSK (PreShared Key)—AES (Advanced Encryption Standard) mode or in WPA2—PSK—AES mode. According to this embodiment, the virtual port VAP0 may be enabled by the user's manual setup, as well as the WPS-based auto-configuration. The virtual port VAP1. is used for WDS (Wireless Distribution System)-based communication.

The virtual port VAP2 is used as a guest port. The guest port is provided to allow the user other than the user of the access point AP to make a connection to the Internet INT. The security of the guest port is set by the user's manual operation. The virtual port VAP3 is used for encrypted communication in WEP (Wired Equivalent Privacy) 128/64 mode. According to this embodiment, the virtual port VAP3 may be enabled by the user's manual setup, as well as the AOSS-based auto-configuration.

The virtual port VAP0 is also used for the WPS process when the CPU 110 or more specifically its receptor 112 detects the user's press of the easy setup button 160. In other words, the virtual port VAP0 is used for communication based on the WPS registration protocol. There is no change in operation of the virtual port VAP1 when the CPU 110 detects a press of the easy setup button 160.

In the virtual port VAP2, however, when the CPU 110 detects a press of the easy setup button 160, the ESSID is changed to “!ABC”. The changed

ESSID is included in beacon sent by the access point AP. This enables even a non-special wireless terminal receiving the beacon to make a connection with the access point AP (virtual port VAP2) by sending a connection request with the setting of ESSID to “!ABC”. In other words, in response to detection of a press of the easy setup button 160, the state of the virtual port VAP2 is changed to the non-restricted state (open state) having no limitation of the connection object connectable with the access point AR The virtual port VAP2 in the non-restricted state is used for the new setup process as described later.

Changing the ESSID to “!ABC” has the following advantageous effects. When the wireless terminal detects a plurality of access points by passive scan or by active scan, such setting of the changed :ESSID enables this access point AP (virtual port VAP2) to be displayed at the top of a list of detected access points. During the first new setup process described later, the user operating the wireless terminal can thus readily find the access point AP as the connection destination in the list, in order to make a connection between the wireless terminal and the access point AP. This improves the user-friendliness. The changed ESSID is preferably a value that is high on the list. in an application of the list displaying the detected access points in a descending order, the changed ESSID may preferably be a value that is at the top on the list in the descending order.

The virtual port VAP3 is used for the AOSS process when the CPU 110 detects a press of the easy setup button 160. More specifically, in response to detection of a press of the easy setup button 160, the ESSID of the virtual port VAP3 is changed to, for example, “ESSID-AOSS” or “ESSID-AOSS1”. The changed ESSID is included in the beacon sent by the access point AP. The wireless terminal receiving this beacon is allowed to make a connection with the access point AP (virtual port VAP3) only when the wireless terminal supports AOSS and receives a start command for the AOSS process within a specified time. The AOSS process starts on establishment of a connection between the wireless terminal and the virtual port VAP3.

### A-3. General Configuration of Wireless Terminal TE2

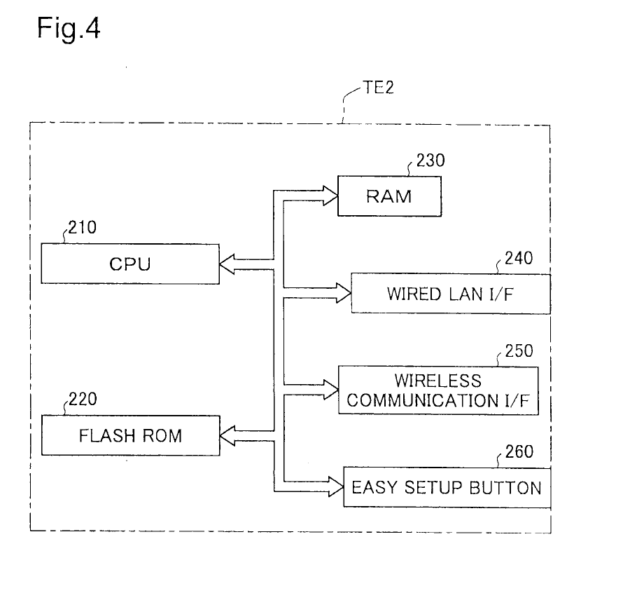

FIG. 4 schematically illustrates the configuration of the wireless terminal TE2. As illustrated, the wireless terminal TE2 includes a CPU 210, a flash ROM 220, a RAM 230, a wired LAN interface 240, a wireless communication interface 250 and the easy setup button 260. The CPU 210, the flash ROM 220, the RAM 230, the wired LAN interface 240, the wireless communication interface 250 and the easy setup button 260 are interconnected by a bus.

The CPU 210 loads and executes a program, such as firmware, stored in the flash ROM 220, on the RAM 230 to control the overall operations of the wireless terminal TE2. The CPU 210 also has the function of performing the second new setup process with the access point AP. The wired LAN interface 240 is an interface for connecting with a wired LAN. According to this embodiment, the wired LAN interface 240 has a wired port. The wired LAN interface 240 is connected with an electronic device without a wireless communication interface. The wireless communication interface 250 is a control circuit for wireless communication in conformity with a wireless LAN standard. The wireless communication interface 250 is controlled by the CPU 210 to implement the functions as the station.

The easy setup button 260 is operated to give a start command for the second new setup process to the wireless terminal TE2. The interface for receiving a start command is not limited to the button as described previously with respect to the easy setup button 160 of the access point AP.

The wireless terminal TE3 differs from the wireless terminal TE2 by: (i) replacement of the function of performing the second new setup process of the wireless terminal TE2 with the function of performing the AOSS process or the WPS process; and (ii) replacement of the easy setup button 260 of the wireless terminal TE2 with the easy setup button SW1 operated to give a start command for the AOSS process or the WPS process. Otherwise the wireless terminal TE3 has the similar configuration to that of the wireless terminal TE2.

### A-4. Connection Setup Process

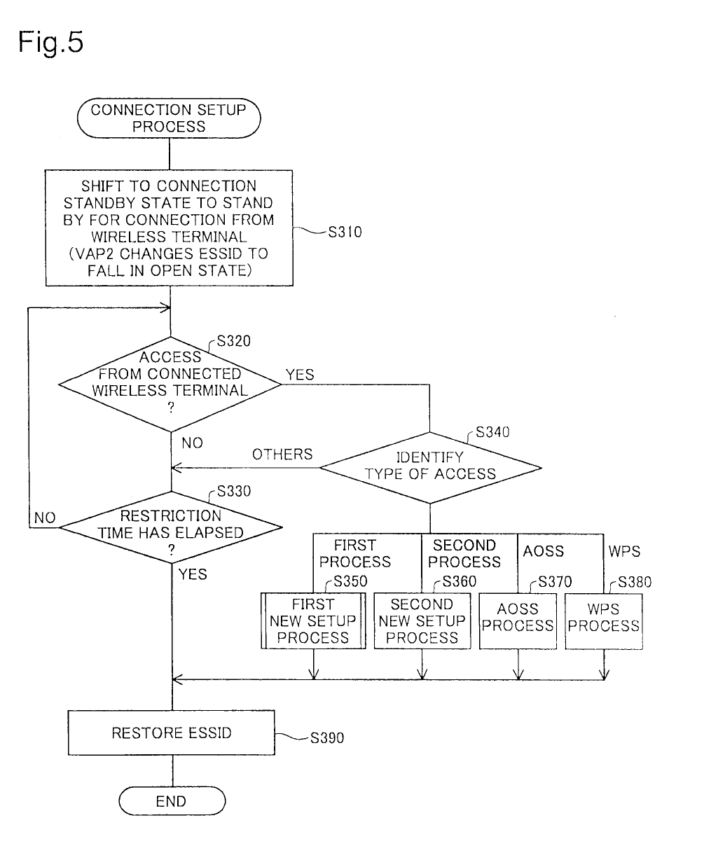

The following describes the connection setup process performed by the access point AP. During the “connection setup process” in the network system 20, the access point AP provides the wireless terminals TE1 to TE3 with configuration information for specific security wireless communication. FIG. 5 shows a flow of the connection setup process. According to this embodiment, the connection setup process is triggered when the CPU 110 or more specifically its receptor 112 of the access point AP detects a press of the easy setup button 160 to receive a start command.

As shown in FIG. 5, on the start of the connection setup process, the

CPU 110 or more specifically its restriction canceller 113 shifts the state of the access point AP to a connection standby state to stand by for a connection from any of the wireless terminals TE1 to TE3 (step S310). In this connection standby state, the virtual ports VAP0 and VAP1 have no changes but the other virtual ports VAP2 and VAP3 have changes as shown in the right column of FIG. 3. The state of each port is described more specifically. The virtual port VAP2 changes the ESSID to fall in the nonrestricted state (open state). In the connection standby state, when receiving a connection request including the changed ESSID from the wireless terminal, the virtual port VAP2 accordingly makes a connection with the wireless terminal sending the connection request. For example, the user of the wireless terminal TE1 (FIG. 1) operates the wireless terminal TE1 to detect the access point AR The user then makes a connection between the detected access point AP (virtual port VAP2) and the wireless terminal TE1 by the user's manual operation. In one example of the “manual operation”, the user may select the access point AP from the list of detected access points (i.e., the list of detected ESSIDs of access points) and give an instruction to connect with the selected access point AP via GUI on the display of the wireless terminal TE1. In response to such user operation, the wireless terminal TE1 sends a connection request including the detected ESSID of the access point AP to the selected access point AP. In another example, when the user of the wireless terminal TE2 (FIG. 1) presses the easy setup button 260 of the wireless terminal TE2, the wireless terminal TE2 detects the access point AP and automatically makes a connection with the detected access point AP (virtual port VAP2). In the description below, the time when the state of the virtual port VAP2 is changed from the restricted state to the non-restricted state is called “restriction cancellation time”.

In the connection standby state, the virtual port VAP0 falls in a standby status for a WPS connection request. The virtual port VAP0 in the standby status makes a connection with the wireless terminal TE3 only when a WPS connection request is received from the wireless terminal TE3 supporting WPS. The virtual port VAP0 does not make a connection with either of the wireless terminals and TE2 that do not support WPS. In the connection standby state, the virtual port VAP3 falls in a standby status for an AOSS connection request. The virtual port VAP3 in the standby status makes a connection with the wireless terminal TE3 only when an AOSS connection request is received from the wireless terminal TE3 supporting AOSS. The virtual port VAP3 does not make a connection with either of the wireless terminals TE1 and TE2 that do not support AOSS. When the user of the wireless terminal. TE3 presses the easy setup button SW1 of the wireless terminal TE3, the wireless terminal TE3 detects the access point AP and automatically makes a connection with the detected access point AP (virtual port VAP0 or virtual port VAP3).

After shifting to the connection standby state, the CPU 110 of the access point AP determines whether there is an access from the wireless terminal making a connection with the access point AP (step S320). For example, after establishment of a connection between the wireless terminal TE1 and the virtual port VAP2, when the user of the wireless terminal TE1 performs an operation to connect with an arbitrary URL (Uniform Resource Locator) by a WEB browser installed in the wireless terminal. TE1, the wireless terminal TE1 has an access to the access point AP (virtual port VAP2). The wireless terminal TE1 accordingly sends an HTTP (Hypertext Transfer Protocol) request to the access point AP (virtual port VAP2). This user operation enables the first new setup process.

When the user of the wireless terminal TE2 presses the easy setup button 260 of the wireless terminal TE2 to establish a connection between the wireless terminal TE2 and the access point AP (virtual port VAP2), the wireless terminal TE2 automatically performs the second new setup process subsequent to establishment of the connection. This process is performed according to an asymmetric protocol by intercommunication between the access point AP and the wireless terminal TE2. According to this embodiment, the second new setup process is performed without encrypting the WPS registration protocol. More specifically, while the registration protocol generally encrypts communication after message M8 specified by the WPS standard, the second new setup process does not encrypt communication after message M8. The message M8 denotes a frame to provide the wireless terminal with configuration information. The second new setup process may alternatively be formed without encrypting the AOSS process. In general, the second new setup process may use the virtual port VAP2 in the non-restricted state to make intercommunication between the access point and the station according to an asymmetric protocol and enable the access point to provide the station with configuration information.

As clearly understood from the above description, the second new setup process is triggered by an access from the wireless terminal TE2 to the access point AP, i.e., transmission of an EAPOL (EAP-over LAN)—Start message as the first action of the registration protocol. When the user of the wireless terminal TE3 presses the easy setup button SW1 of the wireless terminal TE3 to establish a connection with the access point AP (virtual port VAP0 or virtual port VAP3), the wireless terminal. TE3 automatically performs the AOSS process or the WPS process subsequent to establishment of the connection. The AOSS process and the WPS process are known in the art and are thus not described in detail here. Like the second new setup process described above, the AOSS process or the WPS process is also triggered by an access from the wireless terminal TE3 to the access point AP. The decision of step S320 accordingly includes determination of whether there is any access from the wireless terminal for any of the first new setup process, the second new setup process, the AOSS process and the WPS process.

When there is no access from the wireless terminal (step S320: NO), the CPU 110 of the access point AP determines whether elapsed time since the restriction cancellation time reaches a specified restriction time (step S330). When the elapsed time does not yet reach the restriction time (step S330: NO), the CPU 110 returns to step S320. When the elapsed time reaches the restriction time without any access from the wireless terminal (step S330: YES), on the other hand, the CPU 110 or more specifically its restriction restorer 115 restores the ESSID of the virtual port VAP2 to the original value and returns the operating status from the non-restricted state to the restricted state (step S390). This configuration ensures the security.

At step S390, the virtual ports VAP0 and VAP3 are also released from the connection standby state for WPS or AOSS. The virtual ports VAP0 to VAP3 are accordingly restored to the state of ordinary operation shown in the left column of FIG. 3. The restriction time of step S330 may be different values for the virtual ports VAP0, VAP2 and VAP3. For example, the user's manual operation to select the access point AP and give an instruction to connect with the access point AP may take a longer time than the simple press of the easy setup button SW1. The restriction time for the virtual port. VAP2 may thus be set longer than the restriction time for the virtual ports VAP0 and VAP3. This configuration achieves a balance between the time required for the operation of the wireless terminal and the security. The “restriction time” may be a “time length” measured by, for example, a real time clock but may be specified by a period other than the time length, such as a period when the CPU 110 performs a predetermined number of NOP cycles.

When there is an access from the wireless terminal (step S320: YES), on the other hand, the CPU 110 subsequently identifies the type of the access (step S340). More specifically, the CPU 110 identifies which of the first new setup process, the second new setup process, the AOSS process, the WPS process and the others, the access from the wireless terminal is based on. The type of the access is identifiable based on a destination port number included in a TCP header of a communication packet used for the access. The different specifications of the wireless terminals TE1 to TE3 lead to different types of accesses enabled by the wireless terminals TE1 to The wireless terminal TE1 enables an access based on the first new setup process. The wireless terminal TE2 enables an access based on the second new setup process. The wireless terminal TE3 enables an access based on the AOSS process or the WPS process.

When the access is identified as based on the first new setup process (step S340: FIRST PROCESS), the CPU 110 performs the first new setup process to provide the wireless terminal TE1 as the access source with configuration information (step S350). The details of the first new setup process will be described later. When the access is identified as based on the second new setup process (step S340: SECOND PROCESS), the CPU 110 or more specifically its configuration information transmitter 114 performs the second new setup process described above to provide the wireless terminal TE2 as the access source with configuration information (step S360). By the second new setup process, the CPU 110 makes communication with the wireless terminal TE2 and provides the wireless terminal TE2 with configuration information after mutual validation. When the access is identified as based on the AOSS process (step S340: AOSS), the CPU 110 performs the AOSS process to provide the wireless terminal TE3 as the access source with configuration information (step S370). When the access is identified as based on the WPS process (step S340: WPS), the CPU 110 performs the WPS process to provide the wireless terminal TE3 as the access source with configuration information (step S380). When the access is identified as not based on any of the first new setup process, the second new setup process, the AOSS process and the WPS process (step S340: OTHERS), the CPU 110 proceeds to step S330 to repeat the above series of processing until elapse of the restriction time. After performing any of the first new setup process, the second new setup process, the AOSS process and the WPS process, the CPU 110 proceeds to step S390. The connection setup process is terminated after returning the operating status of the access point AP from the non-restricted state to the restricted state at step S390.

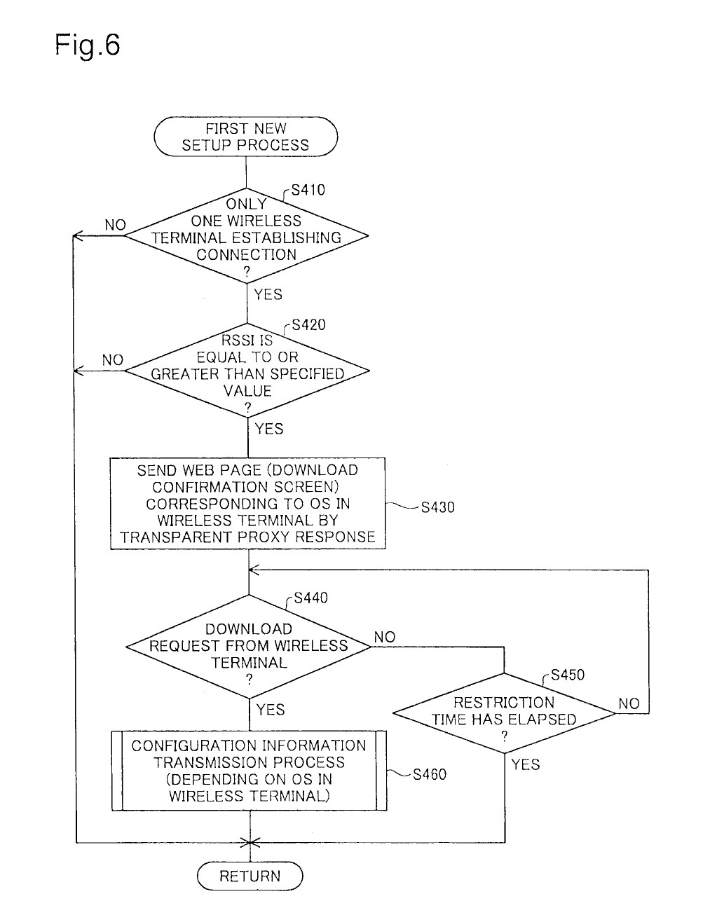

The following describes the first new setup process (step S350) performed in the connection setup process. FIG. 6 shows a flow of the first new setup process. Starting the first new setup process means that (i) the user has operated the wireless terminal TE1 to make a connection with the access point AP (virtual port VAP2) by a WEB browser; and (ii) the wireless terminal TE1 has sent an HTTP request as described above. The CPU 110 accordingly first estimates whether this HTTP request has been sent based on an operation by a user of legitimate authority (hereinafter referred to as “authorized user”).

More specifically, as shown in FIG. 6, on the start of the first new setup process, the CPU 110 determines whether there is only one wireless terminal establishing connection with the access point AP within a specified period since the restriction cancellation time (step S410). This specified period may be a time period equal to the restriction time of step S330 or may be a time period shorter than the restriction time of step S330. When the specified period has not yet elapsed, the CPU 110 may wait for elapse of the specified period. The specified period is not necessarily limited to the “time length” as described above with respect to the “restriction time”.

When there are two or more wireless terminals establishing connection with the access point AP (step S410: NO), there is a possibility that the wireless terminal of the user other than the authorized user, i.e., the user of no legitimate authority (hereinafter referred to as “unauthorized user”), may establish connection with the access point AP. The CPU 110 of the access point AP thus immediately terminates the first new setup process. The CPU 110 accordingly does not send the configuration information in the form of digital data to the wireless terminal establishing connection with the access point AP. This configuration effectively prevents the terminal of the unauthorized user from being provided with the configuration information.

When there is only one wireless terminal establishing connection with the access point AP (step S410: YES), on the other hand, it is estimated that this connection is based on the operation by the authorized user, i.e., by the user who has pressed the easy setup button 160 of the access point AR The user who has pressed the easy setup button 160 of the access point AP is naturally expected to make a connection with the access point AR The presence of only one wireless terminal establishing connection with the access point AP can thus be regarded as a condition that the validity of the user of the wireless terminal is estimable. Even when there is only one wireless terminal establishing connection with the access point AP, however, there is still a little possibility that the wireless terminal TE1 of the authorized user does not make a connection with the access point AP and that the wireless terminal of the unauthorized user makes a connection with the access point AP.

In order to more reliably estimate the validity of the user of the wireless terminal, the CPU 110 subsequently determines whether the received signal strength indication RSSI of the wireless terminal establishing connection with the access point AP is equal to or greater than a specified value (step S420). The authorized user has pressed the easy setup button 160 of the access point AP and is thus expected to be located near the access point AP. This means that the wireless terminal TE1 of the authorized user is expected to be located nearer the access point AP than the wireless terminal of the unauthorized user who externally tries to make a connection with the access point AP. The RSSI of the wireless terminal TE1 of the authorized user is thus higher than the RSSI of the wireless terminal of the unauthorized user. Setting the specified value of RSSI at step S420 to a level that is undetectable unless the wireless terminal is not located near the access point AP enables the following discrimination. The wireless terminal having the RSSI of not less than the specified value is expected to be the wireless terminal TE1 of the authorized user, whilst the wireless terminal having the RSSI of less than the specified value is expected to be the wireless terminal of the unauthorized user. Instead of or in addition to the RSSI, the response speed of wireless communication may be used to estimate the wireless terminal of the unauthorized user. For example, the CPU 110 may estimate the wireless terminal having the lower response speed than a specified speed as the wireless terminal of the unauthorized user. The unauthorized user is generally outside of a room where the access point AP is installed, so that communication between the wireless terminal of the unauthorized user and the access point AP should be made across the wall of the room. This increases the possibility that the wireless terminal of the unauthorized user has the low response speed. The wireless terminal having the lower response speed than the specified speed can thus be estimated as the wireless terminal of the unauthorized user.

When the RSSI is less than the specified value (step S420: NO), there is a possibility that the wireless terminal establishing connection with the access point AP is the wireless terminal of the unauthorized user. The CPU 110 of the access point AP thus immediately terminates the first new setup process. The CPU 110 accordingly does not send the configuration information to the wireless terminal establishing connection with the access point AP. This configuration effectively prevents the terminal of the unauthorized user from being provided with the configuration information, thus ensuring the security.

When the RSSI is equal to or greater than the specified value (step S420: YES), on the other hand, the CPU 110 or more specifically its configuration information transmitter 114 sends a WEB page to the wireless terminal TE1 by a transparent proxy response (step S430). The WEB page sent by this response is screen data to confirm whether the user has the intention to download the configuration information. Like the connection setup software 121 described above, this WEB page is provided for each OS that may be installed in the wireless terminal TE1 and is recorded in the form of digital data in the flash ROM 120. The CPU 110 specifies the WEB page to be sent by the response corresponding to the type of the OS installed in the wireless terminal TE1. The type of the OS installed in the wireless terminal TE1 is identifiable by checking UserAgent included in the HTTP request sent by the wireless terminal TE1. The access point AP may send the WEB page by a response simulating the DNS (Domain Name System) server function of the access point AR instead of the transparent proxy response.

As described above, according to this embodiment, the CPU 110 sends the WEB page to the wireless terminal satisfying both the two conditions, i.e., the first condition that there is only one wireless terminal establishing connection with the access point AP (step S410) and the second condition that the RSSI of the wireless terminal is equal to or greater than the specified value (step S420). According to another embodiment, only one of the first condition and the second condition may be employed as the condition for the CPU 110 to send the WEB page by the response. When the access point AP is located in a specific place where any external illegal access is difficult, for example, in a special private room, the CPU 110 may send the WEB page by the response without either of these decisions as the conditions.

After sending the WEB page by the response, the CPU 110 subsequently determines whether a download request is received from the wireless terminal TE1 (step S440). The download request is sent when the user gives approval for download on a download confirmation screen opened on the display of the wireless terminal TE1 as the sent WEB page. When the download request is not received (step S440: NO), the CPU 110 waits for receiving a download request until a specified restriction time has elapsed (step S450). When the specified restriction time has elapsed without receiving a download request (step S450: YES), the CPU 110 terminates the first new setup process. The processing of steps S430 to S450 may be omitted, as needed basis.

When the download request is received (step S440: YES), the CPU 110 or more specifically its configuration information transmitter 114 performs configuration information transmission process (step S460). The configuration information transmission process is performed to send the configuration information to the wireless terminal TE1 This process depends on the type of the OS installed in the wireless terminal. TE1. This concludes the first new setup process.

The configuration information transmission process (step S460) is described in detail. The configuration information transmission process performs different series of processing corresponding to the type of the OS installed in the wireless terminal TE1. This process is divided into “First configuration information transmission process” and “second configuration information transmission process”. The “first configuration information transmission process” is performed when the OS installed in the wireless terminal TE1 does not allow downloading a communication program but downloads a specific format of a connection settings file. A typical example of this type of OS is iOS. The “second configuration information transmission process” is performed when the OS installed in the wireless terminal TE1 allows downloading a communication program. Typical examples of this type of OS include Android and Windows.

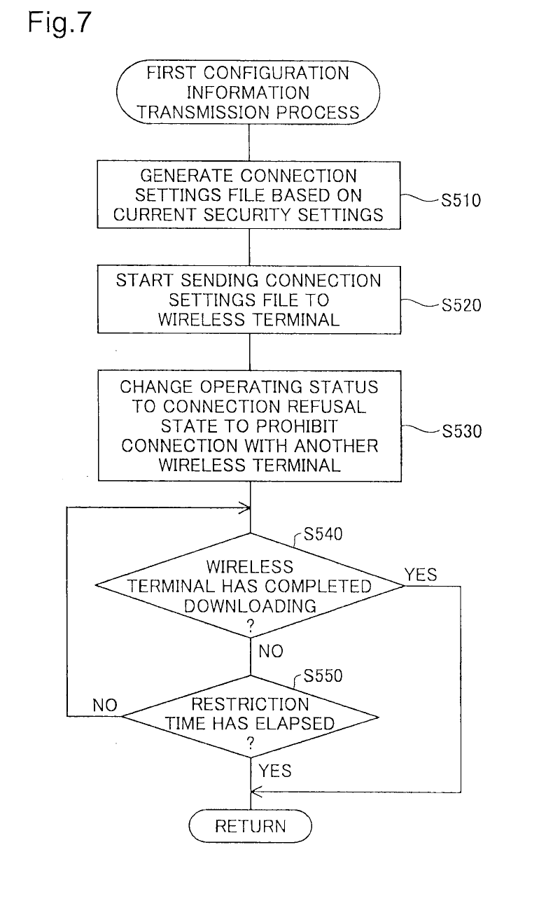

FIG. 7 shows a flow of the first configuration information transmission process. As illustrated, on the start of the first configuration information transmission process, the CPU 110 first generates a connection settings file, based on the current security settings (step S510). The “current security settings” mean the settings for encrypted communication during ordinary operation in any of the virtual ports VAP0, VAP2 and VAP3. One application may determine in advance which of the settings in the virtual ports VAP0, VAP2 and VAP3 is to be employed. Another application may employ the settings of the highest security strength among the settings in the virtual ports VAP0, VAP2 and VAP3. The “connection settings file” is a file in XML (Extensible Markup Language) format or in HTML (HyperText Markup Language) format including configuration information generated based on the current security settings) and is provided in the form of digital data.

After generating the connection settings file, the CPU 110 or more specifically its configuration information transmitter 114 starts sending the connection settings file in the form of digital data to the wireless terminal TE1 (step S520). On the start of transmission of the connection settings file, the CPU 110 or more specifically its rejecter 1116 changes the operating status of the access point AP to a connection refusal state that prohibits the access point AP from making a connection with any wireless terminal other than the wireless terminal TE1 (step S530). Changing the operating status to the connection refusal state prevents the access point AP from establishing connection with any other wireless terminal and newly performing the connection setup process. This effectively prevents the configuration information from being provided to the wireless terminal of the unauthorized user. For example, even when the unauthorized user is somehow aware that the authorized user is making the connection setup of the wireless terminal TE1 and tries to make a connection with the access point AP after the authorized user, this function does not allow the wireless terminal of the unauthorized user to establish connection with the access point AP.

After changing the access point AP to the connection refusal state, the CPU 110 determines whether the wireless terminal TE1 has completed downloading the connection settings file (step S540). When downloading has been completed (step S540: YES), the CPU 110 terminates the first configuration information transmission process. On termination of the first configuration information transmission process, the operating status is returned from the non-restricted state to the restricted state at step S390 (FIG. 5), in order to avoid unnecessary continuation of the non-restricted state. This improves. the security. When downloading has not yet been completed (step S540: NO), on the other hand, the CPU 110 waits for completion of downloading until elapsed time since the start of sending the connection settings file reaches a specified restriction time (step S550: NO).

When the restriction time has elapsed without completion of downloading (step S550: YES), the CPU 110 stops the transmission of the connection settings file and terminates the first configuration information transmission process. The operating status of the virtual port VAP2 is then returned from the non-restricted state to the restricted state at step S390. This configuration effectively prevents an access from any unauthorized user and improves the security, even when it takes a long time to download the connection settings file into the wireless terminal TE1, for example, due to poor communication environment. The decision of step S550 may, however, be omitted as needed basis. The restriction time of step S550 may be specified on the basis of the restriction cancellation time as the starting point, like the restriction time of step S330. In this case, the restriction time of step S550 may be equal to the restriction time of step S330 or may be longer than the restriction time of step S330. This restriction time is not necessarily limited to the time length but may be a certain period as described above with respect to the other restriction times.

When the connection settings file in the form of digital data is downloaded to the wireless terminal IT″ by the above first configuration information transmission process, the contents of the connection settings file are displayed by a WEB browser on the display of the wireless terminal TE1. For example, when the OS installed in the wireless terminal TE1 is iOS, in response to the user's selection of desired configuration information from the displayed contents of the connection settings file, the wireless terminal TE1 registers the selected configuration information in its own memory and sets the selected configuration information.

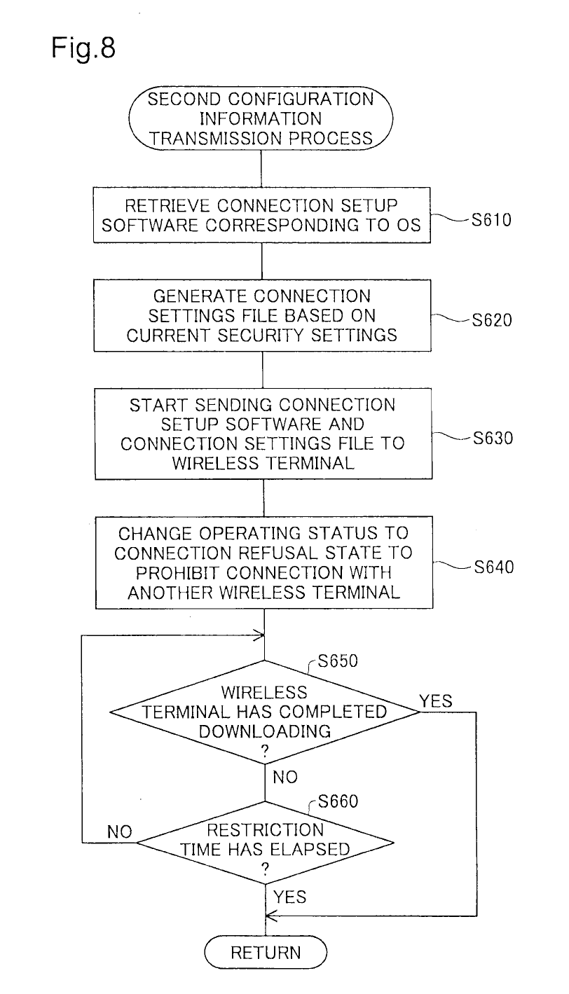

FIG. 8 shows a flow of the second configuration information transmission process. As illustrated, on the start of the second configuration information transmission process, the CPU 110 first retrieves specific connection setup software 121 corresponding to the OS installed in the wireless terminal TE1 from multiple pieces of connection setup software 121 recorded in the flash ROM 120 (step S610). The connection setup software 121 is recorded in the form of digital data in the flash ROM 120.

On retrieval of the specific connection setup software 121, the CPU 110 generates a connection settings file, based on the current security settings (step S620). This processing is identical with the processing of step S520 (FIG. 7) described above. After generating the connection settings file, the CPU 110 or more specifically its configuration information transmitter 114 starts sending the retrieved connection setup software 121 and the generated connection settings file to the wireless terminal TE1 (step S630). On the start of transmission, the CPU 110 or more specifically its rejecter 116 changes the operating status of the access point AP to the connection refusal state (step S640). This processing is identical with the processing of step S530 described above.

After changing the operating status of the access point AP to the connection refusal state, the CPU 110 proceeds to steps S650 and S660. The processing of steps S650 and S660 is identical with the processing of steps S540 and S550 described above and is thus not specifically described here.

When the retrieved connection setup software 121 and the generated connection settings file in the form of digital data are downloaded to the wireless terminal TE1 by the second configuration information transmission process described above, the contents of the connection settings file are displayed by a WEB browser on the display of the wireless terminal TE1. A confirmation screen to ask the user to permit or refuse execution of the downloaded connection setup software 121 is superimposed on the screen of displaying the contents of the connection settings file. When the user's operation gives a permission to execute the connection setup software 121, the connection setup software 121 is loaded on the memory and executed on the wireless terminal TE1, so as to set the configuration information in the wireless terminal TE1.

### A-5. Advantageous Effects

The configuration of the access point AP described above enables the configuration information to be set in the wireless terminal TE1 by requiring the user only to: (i) press the easy setup button 160 to change the operating status of the access point AP (virtual port VAP2) to the non-restricted state; (ii) operate the wireless terminal TE1 to establish a connection between the wireless terminal TE1 and the access point AP; and (iii) access to an arbitrary URL via the WEB browser. Irrespective of whether or not the user has knowledge of wireless communication, the user can thus readily set the configuration information into the wireless terminal TE1 by a simple operation. Additionally, the non-restricted state of the access point AP is returned to the restricted state on the occurrence of a specified event, for example, elapse of the specified period, completion of downloading the configuration information; this ensures the security. This configuration also does not require any special program to be installed in the wireless terminal TE1 and thereby provides high versatility as the system.

When receiving a request for the second new setup process from the wireless terminal TE2, the access point AP performs the second new setup process to send the configuration information to the wireless terminal TE2. In other words, the access point AP automatically establishes mutual communication with the wireless terminal TE2 according to the asymmetric protocol of setting the configuration information in the wireless terminal TE2, so as to send the configuration information to the wireless terminal TE2. This configuration enables the configuration information to be set in the wireless terminal TE2 by only the user's simple operations of pressing the easy setup button 160 and the easy setup button 260.

Additionally, the access point AP supports multi-SSW and uses the virtual ports VAP1 and VAP3 to set the configuration information in the wireless terminal TE3 by the AOSS process or the WPS process. This configuration enables the combined use of the process other than the new setup process and accordingly has excellent versatility. The “process other than the new setup process” may be any process that automatically establishes mutual communication with the wireless terminal according to the asymmetric protocol of setting the configuration information in the wireless terminal, and is not limited to the AOSS process or the WPS process.

### B. Second Embodiment

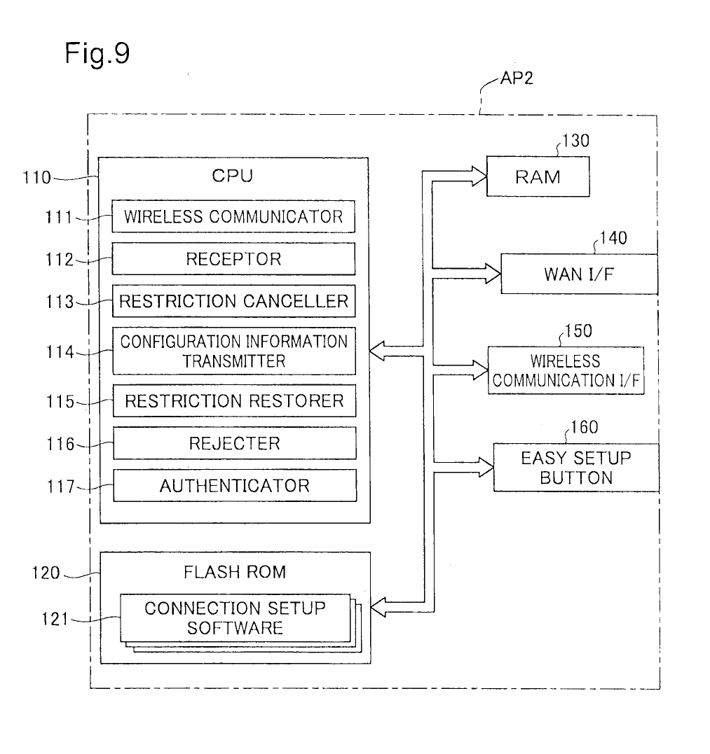

The following describes a second embodiment of the disclosure. FIG. 9 schematically illustrates the configuration of an access point AP2 according to the second embodiment. The configuration of the access point AP2 is almost similar to that of the access point AP of the first embodiment. The differences of the access point AP2 from the access point AP of the first embodiment are that the CPU 110 does not estimate the validity of the user of the wireless terminal based on the and that the CPU 110 additionally serves as an authenticator 117 as shown in FIG. 9. Otherwise the access point AP2 has the similar configuration to that of the access point AP. The like components in FIG. 9 to those of the first embodiment FIG. 2) are expressed by the like numerical symbols to those of FIG. 2. This access point AP2 employs a different flow of the first new setup process from that of the first embodiment, due to the above differences from the access point AP. Otherwise, the processing of the second embodiment is identical with that of the first embodiment. The following describes only the differences from the first embodiment.

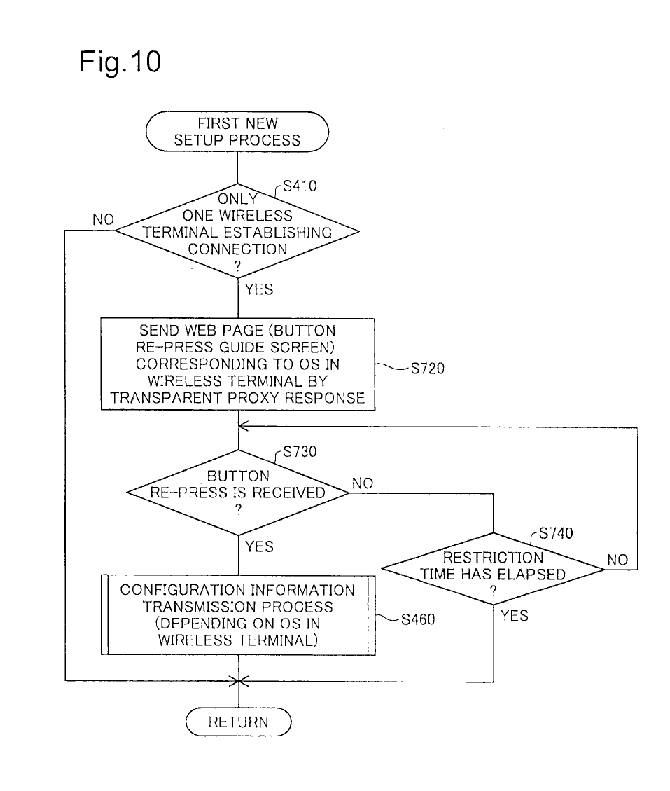

FIG. 10 shows a flow of the first new setup process according to the second embodiment. The like steps in FIG. 10 to those of the first embodiment (FIG. 6) are expressed by the like step numbers to those of FIG. 6. The following describes only the differences from the flow of FIG. 6, and the steps common with FIG. 6 are not specifically described. As shown in FIG. 10, when there is only one wireless terminal establishing connection with the access point AP (step S410: YES), the CPU 110 subsequently determines whether this access is made by the authorized user. Concretely, the CPU 110 or more specifically its authenticator 117 sends a WEB page to the wireless terminal TE1 by a transparent proxy response (step S720). The WEB page sent by this response is screen data to guide the user to press again the easy setup button 160 of the access point AP. Like the first embodiment, this WEB page is specified corresponding to the type of the OS installed in the wireless terminal TE1.

After sending the WEB page by the response, the CPU 110 or more specifically its receptor 112 determines whether the re-press of the easy setup button 160 is received (step S730). When the re-press of the easy setup button 160 is not received (step S730: NO), the CPU 110 waits for receiving the re-press of the easy setup button 160 until elapse of a specified restriction time (step S740: NO). When the restriction time has elapsed without reception of the re-press of the easy setup button 160 (step S740: YES), the CPU 110 terminates the first new setup process. When the re-press of the easy setup button 160 is received (step S730: YES), on the other hand, the CPU 110 or more specifically its authenticator 117 detects successful authentication and proceeds to step S460 (configuration information transmission process). Like the first embodiment, the CPU 110 may confirm whether the user has the intention to download the configuration information, before performing the configuration information transmission process.

As clearly understood from the above description, in the first new setup process of the second embodiment, the user 110 asks the user to press the easy setup button 160 again for user authentication. Only when the easy setup button 160 is pressed again, the CPU 110 detects successful user authentication and performs the configuration information transmission process. The authorized user who has pressed the easy setup button 160 to start the connection setup process is naturally located near the access point AP and is thus able to readily press the easy setup button 160 again. The unauthorized user is not, on the other hand, located near the access point AP and is not able to press the easy setup button 160. This configuration significantly reduces the risk of providing the wireless terminal of the unauthorized user with the configuration information and improves the security only by the extremely simple operation of pressing the easy setup button 160 again.

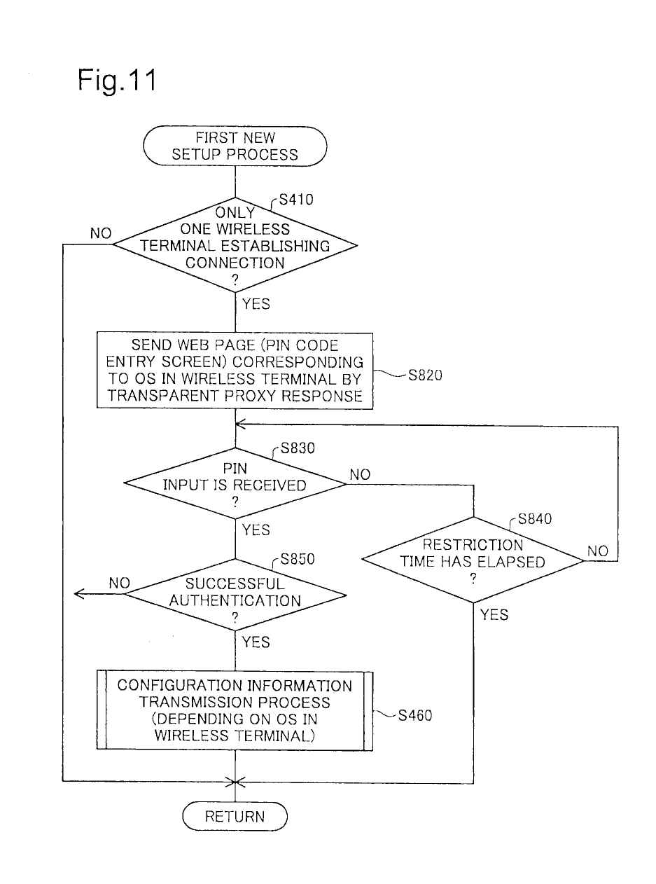

FIG. 11 shows a flow of the first new setup process according to one modification of the second embodiment. The flow of this modification employs a different method of user authentication from that of FIG. 10. The following describes only the differences in the flow of FIG. 11. from that of FIG. 10. As shown in FIG. 11, when there is only one wireless terminal establishing connection with the access point AP (step S410: YES), the CPU 110 or more specifically its authenticator 117 sends a WEB page to the wireless terminal TE1 by a transparent proxy response (step S820). The WEB page sent by this response is screen data to receive the input of a PIN code. A different value is set to the PIN code for each individual of the access point AP. According to this embodiment, the PIN code is attached to the package of the access point AP or to the body of the access point AP at the time of delivery of the access point AP. The user inputs the PIN code attached to, e.g., the package in a PIN code entry screen opened on the display of the wireless terminal TE1.

After sending the WEB page by the response, the CPU 110 or more specifically its authenticator 117 determines whether the input of the PIN code is received from the wireless terminal TE1 (step S830). When the input of the PIN code is not received (step S830: NO), the CPU 110 waits for receiving the input of the PIN code until elapse of a specified restriction time (step S840: NO). When the restriction time has elapsed without reception of the input of the PIN code (step S840: YES), the CPU 110 terminates the first new setup process. When the input of the PIN code is received (step S830: YES), on the other hand, the CPU 110 or more specifically its authenticator 117 checks the received PIN code against a PIN code recorded in advance in the flash ROM 120 for authentication (step S850). In the case of successful authentication (step S850: YES), the CPU 110 proceeds to step S460 (configuration information transmission process). In the case of failed authentication (step S850: NO), on the other hand, the CPU 110 terminates the first new setup process.

Such user authentication using the authentication code significantly reduces the risk of providing the wireless terminal of the unauthorized user with the configuration information and improves the security only by the simple operation of inputting the authentication code.

### C. Third Embodiment

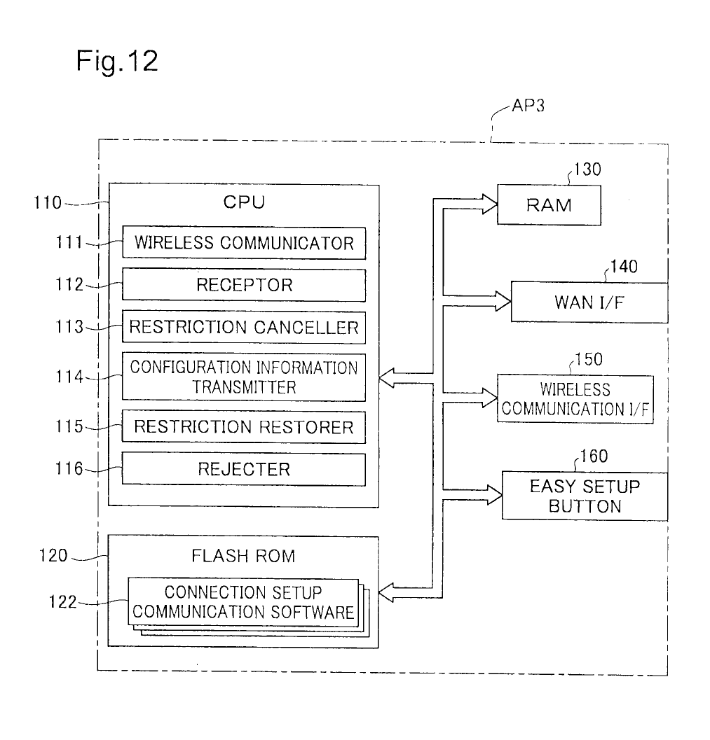

The following describes a third embodiment of the disclosure. FIG. 12 schematically illustrates the configuration of an access point AP3 according to the third embodiment. The configuration of the access point AP3 is almost similar to that of the access point AP of the first embodiment.

The difference of the access point AP3 from the access point AP of the first embodiment is that connection setup communication software 122 in the form of digital data, in place of the connection setup software 121, is recorded in the flash ROM 120 as shown in FIG. 12. The connection setup communication software 122 is a program for a processing flow executed by the wireless terminal during the second new setup process described above. Otherwise the access point AP3 has the similar configuration to that of the access point AP. The like components in FIG. 12 to those of the first embodiment (FIG. 2) are expressed by the like numerical symbols to those of FIG. 2. This access point AP3 employs a different :flow of the second configuration information transmission process from that of the first embodiment, due to the above difference from the access point AP. Otherwise, the processing of the third embodiment is identical with that of the first embodiment. The following describes only the differences from the first embodiment.

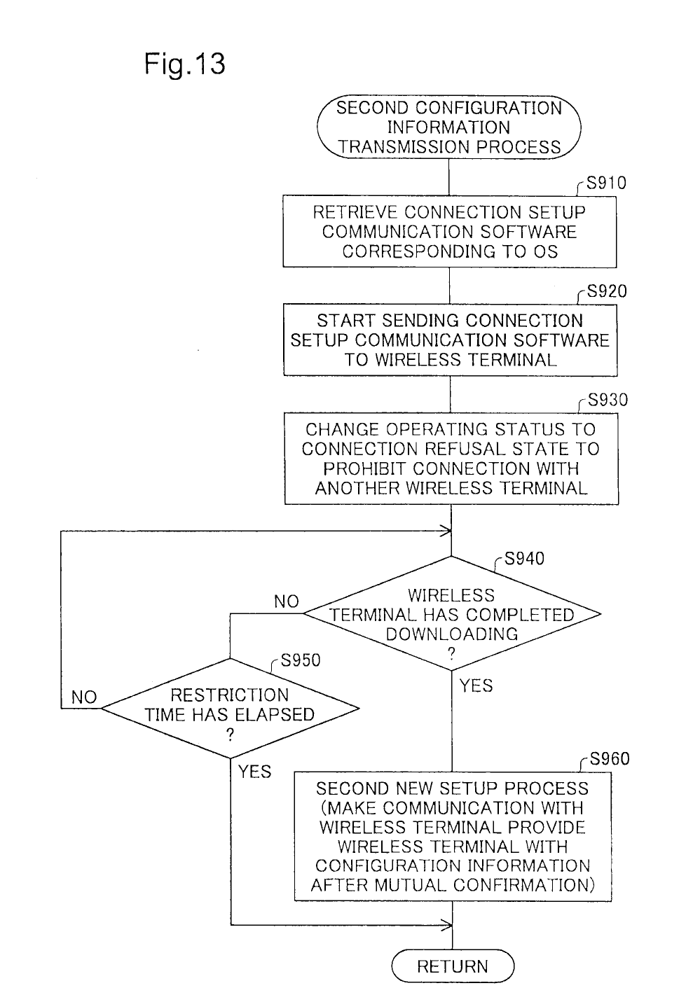

FIG. 13 shows a flow of the second configuration information transmission process according to the third embodiment. As shown in FIG. 13, on the start of the second configuration information transmission process, the CPU 110 first retrieves specific connection setup communication software 122 corresponding to the OS installed in the wireless terminal TE1 from multiple pieces of connection setup communication software 122 recorded in the flash ROM 120 (step S910).

After retrieval of the specific connection setup communication software 122, the CPU 110 or more specifically its configuration information transmitter 114 starts sending the retrieved connection setup communication software 122 to the wireless terminal TE1 (step S920). On the start of the transmission, the CPU 110 or more specifically its rejecter 116 changes the operating status of the access point AP to the connection refusal state (step S930). This processing is identical with the processing of step S530 FIG. 7) described above.

After changing the operating status of the access point AP to the connection refusal state, the CPU 110 determines whether the wireless terminal TE1 has completed downloading the retrieved connection setup communication software 122 (step S940). When downloading has not yet been completed (step S940: NO), the CPU 110 waits for completion of downloading until elapsed time since the start of transmission of the connection setup communication software 122 reaches a specified restriction time (step S950: NO). When the restriction time has elapsed without completion of downloading (step S950: YES), the CPU 110 stops the transmission of the connection setup communication software 122 and terminates the second configuration information transmission process.

When downloading has been completed (step S940: YES), on the other hand, a confirmation screen to ask the user to permit or refuse execution of the downloaded connection setup communication software 122 is opened on the display of the wireless terminal TE1. When the user's operation gives a permission to execute the connection setup communication software 122, the wireless terminal TE1 starts the second new setup process. Accompanied with this, the CPU 110 of the access point AP establishes mutual communication with the wireless terminal TE1 to perform the second new setup process (step S960). The second configuration information transmission process is then terminated. This configuration of the access point AP3 enables the configuration information to be set in the wireless terminal TE1 by only the user's simple operation.

### D. Modifications

The following describes examples of possible modifications made to the above embodiments.

### D-1. Modification 1

In the course of sending the connection settings file in the form of digital data or sending the connection settings file and the connection setup software 121 in the form of digital data during the configuration information transmission process, the access point AP may additionally send a program other than the connection setup software 121. Such modification is also applicable to the second embodiment or the third embodiment. This additional program may be, for example, any of various drivers and application programs for the wireless terminal. This configuration enables various programs to be installed in the wireless terminal, simultaneously with configuring the communication settings for the wireless terminal, thus improving the user-friendliness. For example, a product package of the access point AP may include a storage medium, in which programs for terminals are recorded, such as a CD or a USB memory, in addition to the access point AP. The user is generally required to install the various programs in the wireless terminal by using this storage medium. The above configuration, however, does not require the user's operation of installing the various programs.

For example, the various programs may be recorded in advance in the flash ROM 120. In another example, the various programs may be recorded in an external storage medium having an interface connectable with the access point AP, such as a USB memory. In this application, the user can install the various programs into the wireless terminal, simultaneously with configuring the communication settings for the wireless terminal, only by connecting the USB memory packaged with the access point AP to the access point AP. In yet another example, the access point AP may obtain the various programs via the Internet INT from a specific server, e.g., a server provided by the manufacturer of the access point AP, as needed basis. In another example, the access point AP may notify the wireless terminal of a relevant URL on the Internet, when sending the connection settings file. In this application, the wireless terminal may access the notified URL to download a desired program. In some working environment of the network system 20, the access point AP may obtain the various programs from a server via a local area network. The server may be a network storage device, such as NAS (Network Attached Storage). Any of such modifications desirably reduces the storage capacity of the access point AP or enables effective use of the limited storage capacity. Similarly, it is not necessary to store the connection setup software 121 or the connection setup communication software 122 in the flash ROM 120.

### D-2. Modification 2

According to one modification, when the RSSI is less than the specified value (step S420: NO) (FIG. 6), the CPU 110 of the access point AP may send a WEB page to urge the user to bring the wireless terminal closer to the access point AP, in response to an HTTP request of the wireless terminal TE1. In this application, the CPU 110 may make the comparison of step S420 again after elapse of a specified time period. In another example, the CPU 110 may make the comparison of step S420 again immediately after receiving a response to the transmission of the WEB page or after elapse of a specified time period. For example, the response to the transmission of the WEB page may be sent from the wireless terminal TE1 to the access point AP when the user checks the WEB page on the display of the wireless terminal TE1 and makes an entry for confirmation. Even when the wireless terminal TE1 of the authorized user is located at a position away from the access point AP by a certain distance or more, this configuration enables estimation of the authorized user with higher accuracy.

### D-3. Modification 3

According to the above embodiment, the conditions adopted by the access point AP to send the configuration information to the wireless terminal are that there is only one wireless terminal establishing connection with the access point AP, that the RSSI is equal to or greater than the specified value and that the authentication is successful. The conditions are, however, not limited to the combination of this embodiment but may be another suitable combination. For example, when there are two or more wireless terminals establishing connection with the access point AP, in response to successful authentication by the re-press of the easy setup button 160, the CPU 110 may send the configuration information to the wireless terminal having the RSSI equal to or greater than the specified value. In another example, when there are two or more wireless terminals establishing connection with the access point AP, in response to successful authentication with the PIN code, the CPU 110 may send the configuration information to the wireless terminal that has sent the PIN code of successful authentication.

### D-4. Modification 4

The wireless device, which the access point AP provides with the configuration information, is not limited to the wireless terminal but may be any wireless device operable as a wireless terminal. For example, the wireless device may be an access point having two wireless communication interfaces, wherein one interface is operable as the access point and the other is operable as the station. In another example, the wireless device may be an access point having only one wireless communication interface that is capable of serving as two logical devices, wherein the wireless communication interface is selectively operable as one of the two logical devices, the access point or the station, at any arbitrary time.

The foregoing has described the disclosure in detail with reference to the embodiments. The disclosure is, however, not limited to the above embodiments but various modifications and variations may be made to the embodiments without departing from the scope of the disclosure. For example, the components of the embodiments corresponding to the elements of the respective aspects of the disclosure described above may be implemented by adequate combination, omission or broader conceptualization in aspects of solving at least part of the technical problem or in aspects of achieving at least part of the advantageous effects. The disclosure may be actualized by various applications other than the access point device, for example, a communication configuration providing method, a communication configuration method, a program for an access point, and a storage medium in which such a program is recorded.

The disclosure may be implemented by any of the following aspects and embodiments.

According to a first aspect, there is provided an access point device configured to include a wireless communicator, a receptor, a restriction canceller, a configuration information transmitter and a restriction restorer and to relay wireless communication of a wireless terminal. As long as at least one object of the disclosure is achievable, the access point device may include or may not include the wireless communicator and may include or may not include the receptor. The access point device may also include or may not include the restriction canceller and may include or may not include the configuration information transmitter. The access point device may further include or may not include the restriction restorer.

The wireless communicator may be configured to be capable of making wireless communication in a restricted state where a connection object connectable with the access point device is limited to less than full functionality. The receptor may be configured to receive a specific instruction given by a user. The restriction canceller, in response to the receptor receiving the specific instruction, may be configured to change the restricted state to a non-restricted state where the connection object is not limited. The configuration information transmitter may be configured to send specific digital data required for specified security communication between a connected wireless terminal and the access point device, to the connected wireless terminal, when receiving an access from the connected wireless terminal, in the non-restricted state. The specific digital data may be, for example, configuration information or software executed to install the configuration information into the wireless terminal. The restriction restorer may be configured to return from the non-restricted state to the restricted state on occurrence of a specified event after a restriction cancellation time when the restricted state is changed to the non-restricted state. The connected wireless terminal is the wireless terminal establishing connection with the access point device.

The access point device of this aspect enables the user to set the configuration information in the wireless terminal by the following procedure. The user first gives a specific instruction to the access point device, so as to change the operating status of the access point device to the non-restricted state, and subsequently operates the wireless terminal to establish a connection between the wireless terminal and the access point device. The user then operates the wireless terminal to have an access to the access point device and enables the wireless terminal to obtain configuration information or a setup program. The user can thus readily set the configuration information in the wireless terminal by such operations. Additionally, the access point device returns its operating status from the non-restricted state to the restricted state on the occurrence of a specified event, thus ensuring the security. This configuration is applicable to the wireless terminal without installation of a special program and accordingly has high versatility.

According to a second aspect, there is provided the access point device, wherein the specified event may comprise an event that a specified period has elapsed since the restriction cancellation time.

The access point device of this aspect returns its operating status from the non-restricted state to the restricted state with elapse of time, thus ensuring the security. The expression of “comprising an event that a specified period has elapsed since the restriction cancellation time” means that elapse of the specified period since the restriction cancellation time may be the only specified event or may be an event as one of a plurality of OR (logical sum) conditions.

According to a third aspect, there is provided the access point device, the specified event may comprise an event that the connected wireless terminal completes reception of the specific digital data sent by the configuration information transmitter.

The access point device of this aspect does not continue the non-restricted state after the configuration information is provided to the wireless terminal, thus improving the security. The term “comprising” has the same meaning as that described above with respect to the second aspect.

According to a fourth aspect, there is provided the access point device, wherein in a state that the configuration information transmitter does not start communication to send the specific digital data, the specified event may be identified as an event that a specified period has elapsed since the restriction cancellation time; and in a state that the configuration information transmitter starts communication to send the specific digital data, the specified event may be an earlier event between an event that the connected wireless terminal completes reception of the specific digital data sent by the configuration information transmitter and an event that a specified period has elapsed since the start of communication.

The access point device of this aspect returns its operating status from the non-restricted state to the restricted state with elapse of the specified period or at the time when the digital data is provided to the wireless terminal, thus ensuring the security.

According to a fifth aspect, there is provided the access point device, wherein the configuration information transmitter may send the specific digital data to the connected wireless terminal, only when a specified condition is satisfied.

The access point device of this aspect does not provide the digital data to the wireless terminal without limitation, thus ensuring the security.

According to a sixth aspect, there is provided the access point device, the specified condition may comprise a condition that only one wireless terminal establishes connection with the access point device within a specified period from the restriction cancellation time.

The user who has given the specific instruction to the access point device naturally intends to provide the wireless terminal with configuration information. The presence of only one wireless terminal establishing connection with the access point device accordingly leads to the estimation that the user of the wireless terminal is an authorized user. The access point device of the sixth aspect thus improves the security.

According to a seventh aspect, there is provided the access point device, the specified condition may comprise a condition that a received signal strength indication of the connected wireless terminal is equal to or greater than a specified value.

The user who has given the specific instruction to the access point device is naturally expected to be located at a proximate position near the access point device. When the user at the proximate position operates the wireless terminal to establish connection with the access point device, the RSSI of the wireless terminal is expected to be higher than the RSSI of a wireless terminal of an unauthorized user. The access point device of the seventh aspect thus effectively prevents the configuration information from being provided to the wireless terminal of the unauthorized user, thereby improving the security.

According to an eighth aspect, there is provided the access point device, which may further comprise an authenticator that performs authentication for a user of the connected wireless terminal, wherein the specified condition may comprise a condition that authentication by the authenticator is successful as an authentication condition.

The access point device of this aspect improves the security by user authentication.

According to a ninth aspect, there is provided the access point device, wherein the authenticator may detect successful authentication when the receptor receives the specific instruction again within a specified period after establishment of a connection between the wireless terminal and the access point, and the authentication condition may be that the specific instruction is received again.

The access point device of this aspect enables user authentication only by the user's simple operation to give the specific instruction to the access point device.

According to a tenth aspect, there is provided the access point device, wherein the authenticator may perform the authentication, based on an authentication code sent from the connected wireless terminal to the access point device.

The access point device of this aspect enables user authentication only by the user's simple operation to enter the authentication code.

According to an eleventh aspect, there is provided the access point device, which may further comprise a rejecter that prohibits the access point device from establishing connection with another wireless terminal in the non-restricted state, after the configuration information transmitter starts communication to send the specific digital data.

The access point device of this aspect effectively prevents establishment of unnecessary connection with the wireless terminal, thus improving the security.

According to a twelfth aspect, there is provided the access point device, which may further comprise a connected wireless terminal information acquirer that obtains information describing an operating system installed in the connected wireless terminal, wherein the configuration information transmitter may send the specific digital data to the connected wireless terminal in such a form that is compatible with the operating system installed in the connected wireless terminal.

The access point device of this aspect provides the wireless terminal with configuration information, regardless of the type of the operating system installed in the wireless terminal, thus improving the versatility

According to a thirteenth aspect, there is provided the access point device, wherein the configuration information transmitter may send another digital data usable by the connected wireless terminal, in addition to the specific digital data, to the connected wireless terminal.

The access point device of this aspect enables the user to install various programs used for the wireless terminal in the wireless terminal without any special operation, thus improving the user-friendliness.

According to a fourteenth aspect, there is provided the access point device, wherein when an access from the connected wireless terminal is a request in a predetermined form, the configuration information transmitter may perform mutual communication with the connected wireless terminal according to an asymmetric protocol, so as to send configuration information required for the specified security communication between the connected wireless terminal and the access point device, as the specific digital data to the connected wireless terminal, wherein the asymmetric protocol is configured to set the configuration information in the connected wireless terminal.

The access point device of this aspect provides the wireless terminal with configuration information only by the user's simple operation to give an instruction for specifying the format of the request to the wireless terminal, thus improving the user-friendliness.

According to a fifteenth aspect, there is provided the access point device, which may be configured such that one physical access point device is operable as a plurality of virtual access points that serve as logical access points, wherein the restriction canceller may change status of one specific virtual access point among the plurality of virtual access points to the non-restricted state.

The disclosure may be applicable to an access point device that is configured, such that one physical access point device is operable as a plurality of virtual access points.

According to a sixteenth aspect, there is provided the access point device, which may be configured such that at least one different virtual access point other than the one specific virtual access point having the status changed to the non-restricted state among the plurality of virtual access points is operated as one relevant party of an asymmetric process according to an asymmetric protocol that is configured to set information regarding setup of wireless communication with the wireless terminal, in the wireless terminal by mutual wireless communication with the wireless terminal.

The access point device of this aspect is compatible with the asymmetric process. The asymmetric process may be, for example, conventionally known AOSS process or WPS process.

According to another aspect, there is provided the access point device, wherein the receptor may receive the specific; instruction via at least one of an interface configured to receive a user's direct input and an interface configured to send and receive information by near field communication. This configuration prevents the specific instruction from being given from a position distant from the access point device, thus improving the security.

What is claimed is:

1. An access point device that relays wireless communication of a wireless terminal, comprising:
a wireless communicator that is capable of making wireless communication in a restricted state where a connection object connectable with the access point device is limited to less than full functionality;
a receptor that receives a specific instruction by a user;
a restriction canceller that, in response to the receptor receiving the specific instruction, changes the restricted state to a non-restricted state where the connection object is not limited;
a configuration information transmitter that sends specific digital data required for specified security communication between a connected wireless terminal and the access point device, to the connected wireless terminal, when receiving an access from the connected wireless terminal, in the non-restricted state; and
a restriction restorer that returns the wireless communication from the non-restricted state to the restricted state on occurrence of a specified event after a restriction cancellation time when the restricted state is changed to the non-restricted state, wherein
the connected wireless terminal is the wireless terminal establishing connection with the access point device.

2. The access point device according to claim 1, wherein
the specific digital data is at least one of configuration information used for the specified security communication between the connected wireless terminal and the access point device, and a setup program executed when the connected wireless terminal obtains the configuration information.

3. The access point device according to claim 1, wherein
the specified event comprises an event that a specified period has elapsed since the restriction cancellation time.

4. The access point device according to claim 1, wherein
the specified event comprises an event that the connected wireless terminal completes reception of the specific digital data sent by the configuration information transmitter.

5. The access point device according to claim 1, wherein
in a state that the configuration information transmitter does not start communication to send the specific digital data, the specified event is identified as an event that a specified period has elapsed since the restriction cancellation time, and
in a state that the configuration information transmitter starts communication to send the specific digital data, the specified event is an earlier event between an event that the connected wireless terminal completes reception of the specific digital data sent by the configuration information transmitter and an event that a specified period has elapsed since the start of communication.

6. The access point device according to claim 1, wherein
the configuration information transmitter sends the specific digital data to the connected wireless terminal, only when a specified condition is satisfied.

7. The access point device according to claim 6, wherein
the specified condition comprises a condition that only one wireless terminal establishes connection with the access point device within a specified period from the restriction cancellation time

8. The access point device according to claim 6, wherein
the specified condition comprises a condition that a received signal strength indication of the connected wireless terminal is equal to or greater than a specified value.

9. The access point device according to claim 6, further comprising:
an authenticator that performs authentication for a user of the connected wireless terminal, wherein
the specified condition comprises a condition that authentication by the authenticator is successful as an authentication condition.

10. The access point device according to claim 9, wherein
the authenticator determines successful authentication when the receptor receives the specific instruction again within a specified period after establishment of a connection between the wireless terminal and the access point device, and
the authentication condition is that the specific instruction is received again.

11. The access point device according to claim 9, wherein
the authenticator performs the authentication, based on an authentication code sent from the connected wireless terminal to the access point device.

12. The access point device according to claim 1, further comprising:
a rejecter that prohibits the access point device from establishing connection with another wireless terminal in the non-restricted state, after the configuration information transmitter starts communication to send the specific digital data.

13. The access point device according to claim 1, further comprising:
a connected wireless terminal information acquirer that obtains information describing an operating system installed in the connected wireless terminal, wherein
the configuration information transmitter sends the specific digital data to the connected wireless terminal in a form that is compatible with the operating system installed in the connected wireless terminal.

14. The access point device according to claim 1, wherein
the configuration information transmitter sends another digital data usable by the connected wireless terminal, in addition to the specific digital data, to the connected wireless terminal.

15. The access point device according to claim 1, wherein
when an access from the connected wireless terminal is a request in a predetermined form, the configuration information transmitter performs mutual communication with the connected wireless terminal according to an asymmetric protocol, so as to send configuration information required for the specified security communication between the connected wireless terminal and the access point device, as the specific digital data to the connected wireless terminal, wherein
the asymmetric protocol is configured to set the configuration information in the connected wireless terminal.

16. The access point device according to claim 1, wherein
the access point device is configured such that one physical access point device is operable as a plurality of virtual access points that serve as logical access points, wherein
the restriction canceller changes status of one specific virtual access point among the plurality of virtual access points to the non-restricted state.

17. The access point device according to claim 16, wherein
the access point device is configured such that at least one different virtual access point other than the one specific virtual access point having the status changed to the non-restricted state among the plurality of virtual access points is operated as one relevant party of an asymmetric process according to an asymmetric protocol that is configured to set information regarding setup of wireless communication with the wireless terminal, in the wireless terminal by mutual wireless communication with the wireless terminal.

18. The access point device according to claim 1, wherein
the receptor receives the specific instruction via at least one of an interface configured to receive a user's direct input and an interface configured to send and receive information by near field communication.

19. A communication configuration providing method that provides a wireless terminal with configuration information, which is used to enable specified security communication between an access point device and the wireless terminal, the communication configuration providing method comprising:
changing a restricted state where a connection object connectable with the access point device is limited to less than full-functionality to a non-restricted state where the connection object is not limited, in response to receiving a specific instruction by a user;
sending digital data that is used to enable a connected wireless terminal that has established connection with the access point device, to obtain the configuration information, to the connected wireless terminal, when receiving an access from the connected wireless terminal, in the non-restricted state; and
returning from the non-restricted state to the restricted state on occurrence of a specified event after a restriction cancellation time when the restricted state is changed to the non-restricted state.
